(19) United States
(12) Patent Application Publication
(10) Pub. No.: US 2004/0257369 A1
(43) Pub. Date: Dec. 23, 2004

(54) Integrated video and graphics blender

(76) Inventor: Bill Fang, Rockwall, TX (US)

Correspondence Address: John A. Thomas, Esq, Suite 2200, 13355 Noel Road, Dallas, TX, 75240-1518, US

(21) Appl. No.: 10/463,031

(22) Filed: Jun. 17, 2003

(51) Int. Cl. G06F 15/00; G06T 1/00

(52) U.S. Cl. 345/501

(57) ABSTRACT

A system and method provides for blending video data with graphics data and outputting video frames comprising blended video and graphics. There is a host computer capable of communicating with one or more integrated computer graphics cards, and at least one integrated computer graphics card. The integrated computer graphics card comprises a local bus; an MPEG decoder communicating with the local bus; a first video frame buffer communicating with the MPEG decoder; and a graphics processor communicating with the MPEG decoder by means of a dedicated digital video bus. The graphics processor further communicates with the local bus and a second frame buffer communicates with the graphics processor, for blending video data and graphics data in the second frame buffer according to alpha data from the host computer system. An analog TV decoder communicates with the graphics processor by means of the dedicated digital video bus, and a video output port connects to the graphics processor, for outputting video frames comprising blended video and graphics.

### FIELD OF INVENTION

This invention relates to computer graphics, and in particular to systems and methods for displaying input computer graphics data and input video data on a single display surface.

### BACKGROUND

The merging of graphic technology and video technology is becoming more evident every day. Television stations are using this technology to provide more information to the viewer while broadcasting daily programs. While news is being broadcast by video, graphical data is being used to provide stock quotes, weather information and headline news. Electronic signs using flat panels are also becoming a new way of providing information with the combination of video and graphic in the places where the traditional paper posters have been used.

Combining digital video with true-color computer graphic can generate a powerful electronic display for information, education and entertainment (these channels are also known as “barker” channels). In most of the applications, multiple monitors are also deployed to provide entertainment and information displays. To drive multiple monitors with graphic and video requires a computer equipped with multiple video outputs. All of the outputs should also be flexible to drive different types of monitors, such as NTSC/PAL TV monitors, VGA monitors and high definition TV monitors. Such a system must be able to decode MPEG video and rendering graphics.

Prior-art systems typically have accomplished this result by defining masks for representing windows, thus defining a video display area and a graphics display area in the window. After this operation, pixels representing the respective video and graphics data are written into the respective sub-windows.

The present invention uses the “alpha channel” present in modern 32-bit graphics devices to efficiently compose a blended display window of video data and graphics data. The alpha channel (transmitting “alpha data”) is a eight-bit channel in addition to the three eight-bit color channels of red, green, and blue. The alpha data allows the selective blending of two overlying display surfaces by setting the level of transparency from transparent to opaque according to the alpha data. Such methods not only allow overlay of different data, but also the creation of special effects.

In one embodiment of the present invention, a computer graphics card has a plurality of channels for blending graphics and video data. This allows users to have one piece of equipment serve up several different functions to each channel for hospitality customers, such as hotel guests, parking lot customers, hospital patients or students in dormitory rooms. In the prior-art systems there are independent and dedicated sets of equipment for each function, such as movies, graphics menus, Internet access, music on demand, and so forth. Each of these dedicated pieces of equipment must be integrated into a switch so they can be shared by each customer. The present invention allows for any given video channel to provide multiple functions to the customer. Each channel can be either video, or graphics or a combination of the two. One integrated graphics card can drive multiple areas of interest on the same screen. Each display surface can have video as well as live or delayed information data such as stock, weather, sports, prices, specials or news which can overlay on the video, or be dedicated to a section of the screen.

### SUMMARY

The invention is embodied in a system for blending video data with graphics data and outputting video frames comprising blended video and graphics. The system comprises a host computer; the host computer capable of communicating with one or more integrated computer graphics cards, and at least one integrated computer graphics card. The integrated computer graphics card comprises a local bus; an MPEG decoder communicating with the local bus; a first video frame buffer communicating with the MPEG decoder; and a graphics processor communicating with the MPEG decoder by means of a dedicated digital video bus. The graphics processor further communicates with the local bus and a second frame buffer communicates with the graphics processor, for blending video data and graphics data in the second frame buffer according to alpha data from the host computer system. An analog TV decoder communicates with the graphics processor by means of the dedicated digital video bus, and a video output port connects to the graphics processor, for outputting video frames comprising blended video and graphics. In general there is a bridge between the local bus and a host computer bus for accepting commands to the integrated computer graphics card from the host computer.

The invention is also embodied in a method for blending video and graphics data on the same display. The method uses an integrated computer graphics card connected to a host computer. The card has an MPEG decoder, a graphics processor and a graphics frame buffer. The method comprises the following steps: transferring MPEG data and commands to an MPEG decoder from a host computer; transferring graphics data and commands to a graphics processor from the host processor; transferring alpha data from the host processor to the graphics processor; decoding and scaling MPEG data in the MPEG processor; transferring decoded and processed MPEG data from the MPEG decoder to the graphics processor; blending the video and graphics data in the graphics frame buffer according to the alpha data; and, outputting the blended video data.

### DESCRIPTION OF DRAWINGS

FIG. 1 is a block diagram of one channel of the preferred embodiment of an integrated computer graphics card.

FIG. 2 is a functional block diagram of the preferred embodiment.

FIG. 3 is a block diagram of a plurality of the embodiments depicted in FIG. 1, for an integrated computer graphics card having multiple channels.

FIG. 4 is a flow diagram illustrating the processing logic of the preferred embodiment.

FIG. 5 shows the flow of control in a complete application of the preferred embodiment.

### DETAILED DESCRIPTION

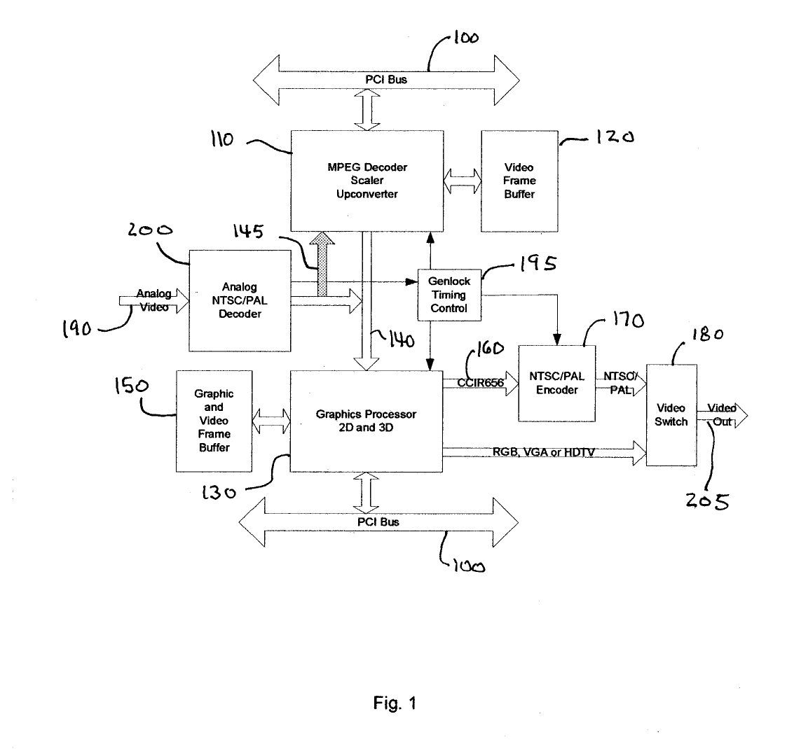

The basic implementation for each output port involves a MPEG video decoder (110), an analog video decoder (200), a 2D/3D graphics processor (130) and a graphics/video frame buffer (150) for blended graphics and video as shown in FIG. 1. In most cases, the blending function will be executed in the graphic processor (130), as depicted in FIG. 1. This implementation will allow the output of graphics, video, or a composition of video and graphics. The composition process can be done with alpha blending or color keying. Alpha blending allows for levels of transparency control. Color keying allows for blending of video and graphic signals by matching pixel color values. Video scaler support in the design, preferably in the MPEG decoder (110) will allow for resizing of video to fit in a window, or up-scaling a standard definition video resolution to an HDTV video resolution. An optional analog video signal (145) may also be input to the MPEG decoder (110). A suitable MPEG decoder chip for this application is the EM8476, manufactured by Sigma Designs. A suitable graphics chip is the V2200, manufactured by Micron Corporation. The reader will understand that similar chips by other manufacturers may be used in embodiments of the invention by those skilled in the art.

In the preferred embodiment a flexible implementation is used at each video output port (205) to provide all possible display formats. A VGA/HDTV random-access memory digital-to-analog converter (RAMDAC) (175) internal to the graphics processor is used to encode VGA and HDTV resolutions, and a NTSC/PAL encoder (170) is used for NTSC and PAL output formats. A software controllable video switch (180) is also in use to automatically switch the correct converter (RAMDAC or NTSC/PAL encoder) for output based on the selection of output resolution.

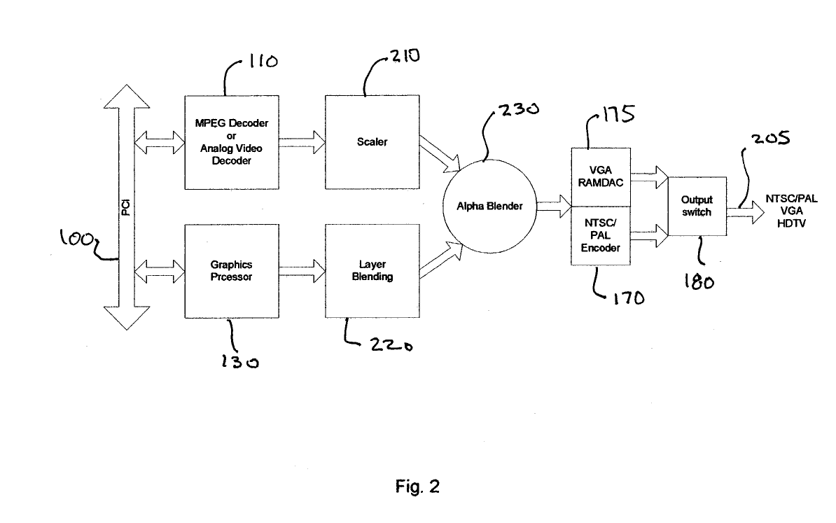

FIG. 2 shows the functional diagram of an output port from point of view of the application software. The MPEG decoder (110) and the graphics processor (130) are connected on the system bus (100), preferably a peripheral-component interconnect (PCI) bus. (In the preferred embodiment, the integrated computer graphics card has more than one channel, and thus will include a local PCI bus (100)). The host computer (300) transfers MPEG data streams and commands to the MPEG decoder (110) via the host system PCI bus (310). The MPEG data will be processed and decoded by the MPEG decoder (110) to provide un-compressed video pixels. Once the video is uncompressed and stored in the video frame buffer (120), the video can then be further processed by the MPEG decoder (110) to scale down the image or to up-convert the image. The video frame buffer (120) will generally be a part of the MPEG decoder (110). After the video is processed to the desired size, the video data will then be transferred into a second frame buffer (150) connected to the graphics processor. The communication between the MPEG decoder (110) and the graphics processor (130) should preferably be a direct digital interface (140) such as the VESA VIP (video input port) interface used in the preferred embodiment, for transferring uncompressed digital YUV video to the graphics processor's frame buffer.

Referring to FIG. 2, the host computer system (300) transfers the graphics data and commands to the graphic processor (130) via the host system PCI bus (310) and the local PCI bus (100) on the integrated graphics card. The preferred embodiment of the invention is illustrated using software interfaces provided by the Microsoft Corporation. The reader should note that the invention may be adapted to other interfaces in other operating systems, and the use of the Microsoft system is illustrative only. Microsoft's Graphic Display Interface (GDI) and Direct Draw interface are used in the preferred embodiment for the graphical data input from the host computer system (300).

The MPEG decoder (110) provides both scaler and upconverter functions (210). The scaler function (210) can be used to scale the video down to a window on the screen. The up-converter function (210) can be used to convert a standard definition video image to a high definition format such as 480p, 720p or 1080i. The second frame buffer (150) provides three surfaces: video surface, graphic surface and blending surface. The video surface contains real time import of video data from the MPEG decoder (110), or the analog video decoder (200). The graphic surface contains the graphical images provided from the host computer system (300). The host computer system (300) defines the alpha value of each pixel for the blending surface. Given that all data (video, graphic and alpha) are stored in one frame buffer (150), we have the most flexibility to manipulate the graphics and video for the final presentation of the image. Video can be in full screen or in a scaled window. Multiple graphic regions can be placed behind or in front of the video surface by the layer blending function (220). Transparencies can be created between surfaces. Based on the alpha values, the alpha blender function (230) will mix the video over graphics or graphics over graphics, with different levels of transparencies to provide the final video and graphic image to the output digital-to-analog converters, whether internal to the graphic processor or external as in an NTSC encoder. The final image resolution is set by the appropriate RAMDAC (175) to provide VGA or HDTV output. If NTSC or PAL output format is selected, an external NTSC/PAL video encoder (170) must be used to convert the digital data to analog NTSC/PAL signal. The graphics processor (130) provides the digital pixel data to the NTSC/PAL encoder (170) via a second dedicated digital video bus (160), a CCIR656 bus in the preferred embodiment.

Referring again to FIG. 1, the analog video input signal (190) provides two functions for this design. The analog video signal (190) serves as a second video source. Also, the analog video signal (190) can also be used as the generator-locking device (195) (genlock) signal to provide synchronization timing to the MPEG decoder (110), graphics processor (130) and the NTSC/PAL video encoder (170). In the preferred embodiment, the genlock control circuit (195) extracts the video timing information (pixel clock, horizontal sync, vertical sync and subcarrier frequency) from the input analog video signal (190). This video timing is then provided to the MPEG decoder (110), graphics processor (130), output digital-to-analog converter in the graphics chip (not shown), and the NTSC/PAL video encoder (170) to synchronize the video clock, horizontal sync and vertical sync. This genlock circuit (195) provides the ability to output video signals (205) that are perfectly synchronized with the input signal (195). Additional circuitry (not shown) is preferably in place to detect the presence of an input analog video signal (195). In the case of losing the video input signal (195), the genlock control (195) signal will automatically switch to a locally generated video timing to drive all of the components on the board. The analog video signal (composite, S-video or component video) (190) is decoded by the video decoder (200), and the digital video pixel data is transferred into the graphics processor's frame buffer (150) along the first dedicated digital video bus (140) for further processing.

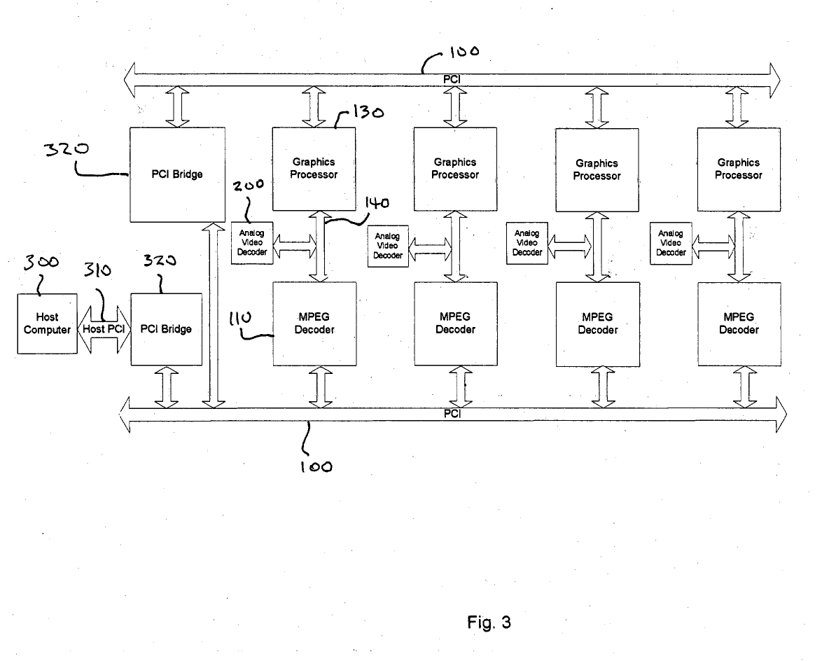

Four ports of graphic and video can be implemented on a single slot PCI form factor card. A top-level diagram of the 4-port MPEG video and graphic card is shown schematically in FIG. 3. For the most flexible design, the graphic processors (130) and the MPEG decoders (110) on such a card should be PCI devices. An analog video decoder (190) can also be added at each port to provide decoded analog video into the graphics processors' frame buffers (150), as discussed above.

A circuit card implementation as described here will turn any computer with PCI slots into a multi-port graphic and video server. The flexible output format design allows the user to use each output as a video port for MPEG movie playback in a video server, or convert the same output into a Windows 2000/XP desktop display device to run standard windows applications such as Internet Explorer for Web access, or Microsoft Power Point for graphics presentation.

### Processing Logic

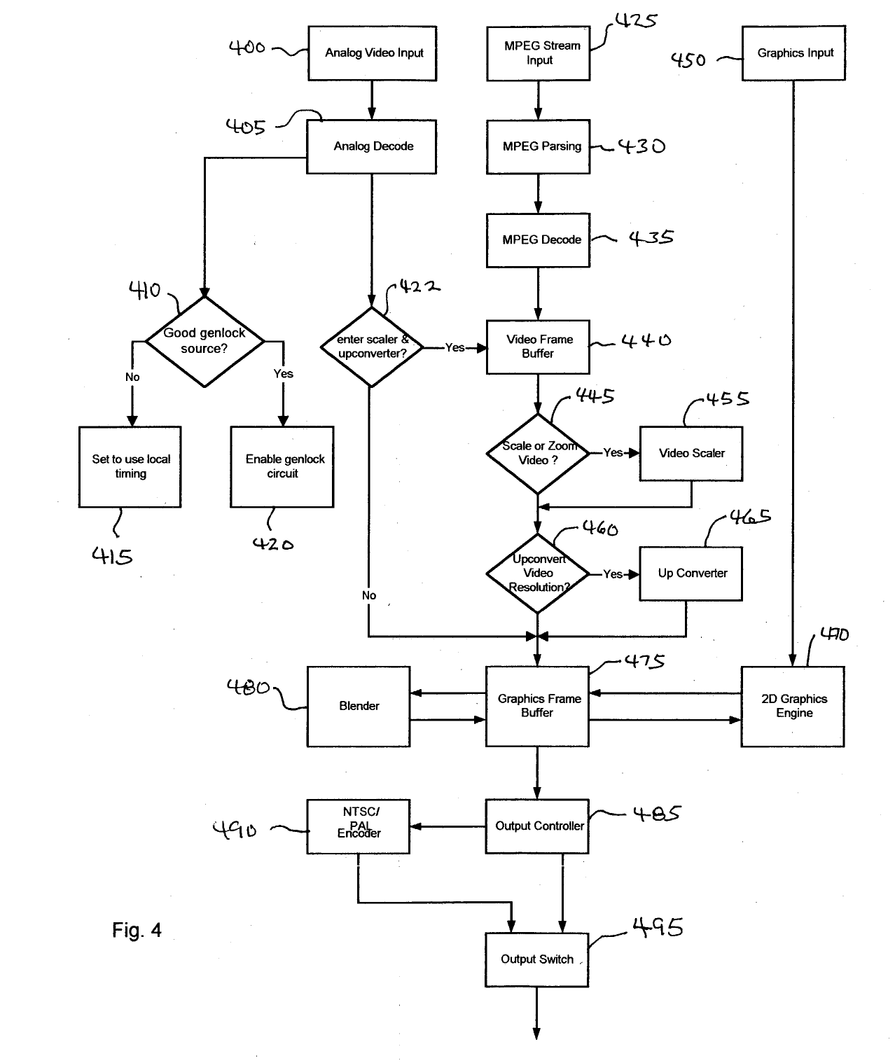

FIG. 4 shows the processing logic of the preferred embodiment. Note that FIG. 4 represents one processing channel among several channels that may be located on the same integrated graphics card.

An analog video signal may be input at step 400. If the analog signal is present, it will be decoded to digital format at step 405 and selectively passed to the scaler and upconverter functions at step 422., Analog video data is sent at step 422 to the MPEG decoder (110) If up or down scaling is required. Step 410 checks for the presence of a good genlock source from any analog signal (190) present. If a good genlock source is present, step 420 enables the genlock circuit; if not, the system is set at step 415 to use local timing, as described above.

A stream of MPEG data enters at step 425. The MPEG data stream is parsed (step 430), decoded (step 435), and sent to a video frame buffer (120) at step 440. If a request to scale or zoom is present at decision block 445, the decoded MPEG data is sent to a video scaler, generally a part of an MPEG decoder chip (110), and scaled at step 455. If no scaling or zooming is required, decision block 460 determines if video resolution upconversion is requested; if so, the data is sent to an upconverter, again, generally a part of an MPEG decoder chip (110), to be upconverted at step 465.

Decoded and possibly scaled, zoomed, and upconverted video data is sent to the graphics frame buffer (150) at step 475. At this step, graphics data input to the card (step 450) is processed by the graphics processor (130) and also placed in the graphics frame buffer (150). Blending of the graphics and video data now takes place in the graphics frame buffer (150) at step 480 according to alpha data input to the graphics processor (130) over the system bus (100).

An output controller function at step 485 creates two outputs, either NTSC/PAL encoded signals, or RGB, VGA, or HDTV signals. The output controller step 485 sends data to an NTSC/PAL encoder (170) for encoding to analog format at step 490. This output, and the direct outputs (RGB, VGA, or HDTV), are selected as output in the switch function at step 495, using the video switch (180).

### Application Programming Interface

Each output port of the preferred embodiment is represented under Microsoft Windows 2000/Windows XP as a standard “display device,” and each supports Microsoft's Direct Draw API and Microsoft's Graphics Display Interface (GDI). A Direct Draw device manages a Windows 2000 application program's access to the frame buffer on the graphics processor for 24-bit RGB color-encoded channel for graphics processing, an 8-bit alpha channel for graphics and video blending, and a CCIR601 YUV color-encoded channel for de-compressed video processing. Each output port operates as a normal display device in the Windows desktop. Normal Direct Draw and GDI operations are used to create and position graphical and video surfaces and control the degree of blending. A Windows2000/XP device driver is implemented to control the MPEG decoder and analog video decoder to provide video data flow into the frame buffer.

The preferred embodiment preferably includes an application programming interface (API) (520) for providing a plurality of procedures that allow an application program executed by the host computer to communicate with the integrated computer graphics card. This API (520) resides functionally above the Windows GDI or Direct Draw interfaces, and drivers communicating with the MPEG decoder or decoders. The top-level API functions comprise:

A function to create a device interface between an application program running on the host computer and an integrated computer graphics card (535). This function is called “AGfxDevice” in the preferred embodiment of the API (520).

A function to create and initially position one or more non-blended browser windows and a single video window on a given display (540). This function is called “AGfxDisplay” in the preferred embodiment of the API (520).

A function to control the visibility, position and translucency of a blended browser window (545). This function is called “AGfxIEWindowB” in the preferred embodiment of the API (520).

A function to control the position and visibility of a non-blended browser controlled window (550). This function is called “AGfxIEWindowNB” in the preferred embodiment of the API (520).

A function to control the position and visibility of a display video window, and to create one or more blended browser-controlled overlay windows (555). This function is called “AGfxMPEGWindow” in the preferred embodiment of the API.

A function to control the visibility, position, scroll rate and translucency of a blended scrolling bitmap window (560). This function is called “AGfxScrollingWindowB” in the preferred embodiment of the API (520).

A function to interface to control the visibility, position, scroll rate and translucency of a non-blended scrolling bitmap window (565). This function is called “AGfxScrollingWindowNB” in the preferred embodiment of the API (520).

The API preferably is a set of computer-executable instructions stored in the host computer (300) in that computer's hard disk, in RAM, ROM, or removable magnetic media.

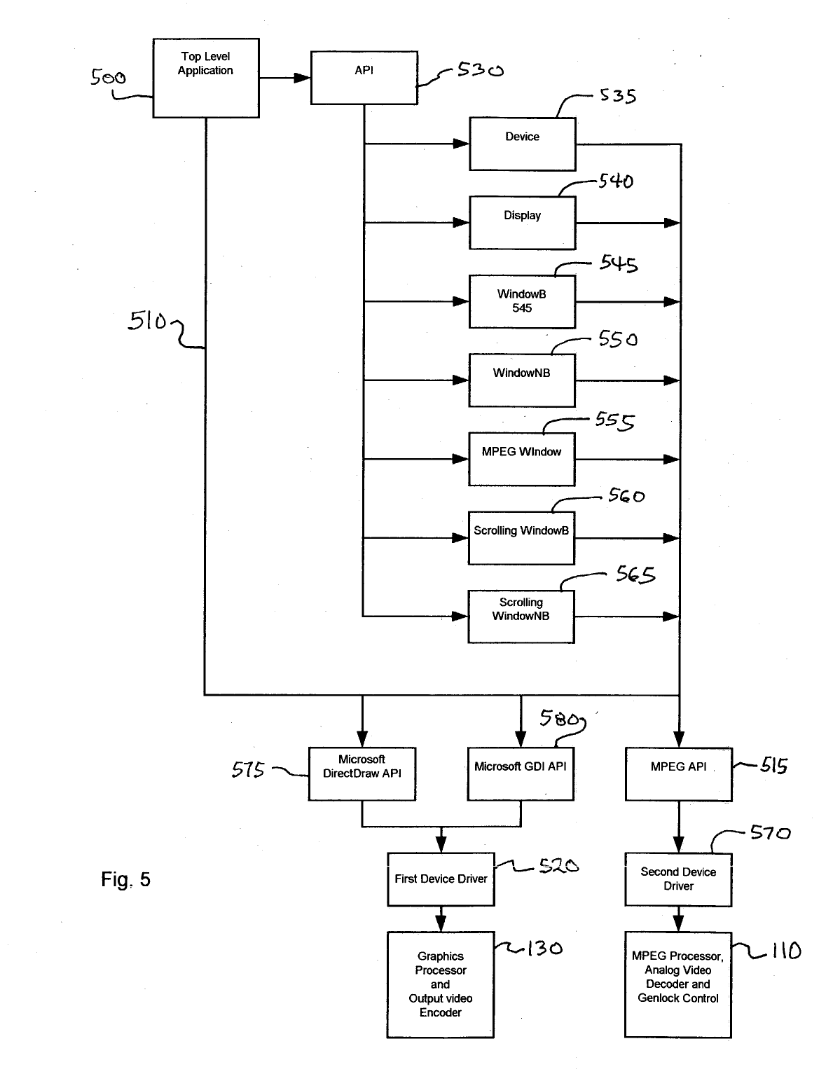

FIG. 5 shows the flow of control in a complete application of the preferred embodiment. A top-level application (500) communicates (510) with the MicrosoftDirect Draw interface (570) and GDI interfaces (580) for the graphics portion of the desired presentation. In the preferred embodiment, the top-level application may also communicate with the MPEG decoder (110) directly though an MPEG API (575) dedicated to that purpose. The Microsoft interfaces (570, 580) communicate through a first device driver (520) with the graphics processor (130). The top-level application (500) also communicates with the claimed API (530) for the video portion of the desired presentation. The API (530) communicates through various top-level API functions as just described with a second device driver (570), and thus with the MPEG decoder (110). FIG. 5 also shows the API top-level functions just described.

Given the implementation just described with standard Microsoft Display interfaces (Direct Draw and GDI), standard HTML pages rendered in a browser can be used as a tool for an overlaid video and graphics presentation at an output (205). A standard HTML page is rendered in a browser control window and the output is transferred to a Direct Draw overlay surface. The layout position of each HTML surface, its level of blending with any video input and a transparency color can be specified. The position and size of a video surface, if required, can also be specified. The creation of the final output signal is transparent to the users as they only need to specify the source HTML pages and video and layout information. This facilitates the production of high-quality “barker” output using simple and widely available HTML creation packages.

I claim:

1. An integrated computer graphics card comprising
a. a local bus;
b. an MPEG decoder communicating with the local bus;
c. a first video frame buffer communicating with the MPEG decoder;
d. a graphics processor communicating with the MPEG decoder; the graphics processor further communicating with the local bus;
e. a second frame buffer communicating with the graphics processor, for blending video data and graphics data in the second frame buffer according to alpha data from the host computer system;
f. a video output port connected to the graphics processor, for outputting video frames comprising blended video and graphics; and,
g. a bridge between the local bus and a host computer bus for accepting commands to the integrated computer graphics card from the host computer.

2. The integrated computer graphics card of claim 1, where the video output port further comprises:
a. a video encoder connected to the graphics processor, for encoding digital video data to analog television formats; and,
b. a video switch connected to the video encoder and the graphics processor for switching the output of the integrated graphics card between NTSC/PAL TV outputs and VGA/HDTV outputs.

3. The integrated computer graphics card of claim 1, further comprising an analog-to-digital decoder, the analog-to-digital decoder output connected to the graphics processor by means of a first dedicated digital video bus.

4. The integrated graphics card of claim 3, further comprising a genlock control; the genlock control operatively connected between the analog-to-digital decoder, the MPEG decoder, and the video encoder, for synchronizing the timing of analog television signals input to the analog-to-digital decoder with the output of the video encoder.

5. The integrated computer graphics card of claim 1, where the MPEG decoder is further capable of scaling output digital video frames responsive to commands from the host computer.

6. The integrated computer graphics card of claim 1, where the local bus is a PCI bus.

7. A system for blending video data with graphics data and outputting video frames comprising blended video and graphics, the system comprising:
a. a host computer; the host computer capable of communicating with one or more integrated computer graphics cards;
b. at least one integrated computer graphics card; the integrated computer graphics card comprising:
(1) a local bus;
(2) an MPEG decoder communicating with the local bus;
(3) a first video frame buffer communicating with the MPEG decoder;
(4) a graphics processor communicating with the MPEG decoder by means of a first dedicated digital video bus; the graphics processor further communicating with the local bus;
(5) a second frame buffer communicating with the graphics processor, for blending video data and graphics data in the second frame buffer according to alpha data from the host computer system;
(6) a video output port connected to the graphics processor by a second dedicated digital video bus, for outputting video frames comprising blended video and graphics; and,
(7) a bridge between the local bus and a host computer bus for accepting commands to the integrated computer graphics card from the host computer.

8. The system for blending video data with graphics data and outputting video frames comprising blended video and graphics of claim 7, where the video output port further comprises:
a. a video encoder connected to the graphics processor, for encoding digital video data to analog television formats; and,
b. a video switch connected to the video encoder and the graphics processor for switching the output of the integrated graphics card between NTSC/PAL, and VGA or HDTV formats.

9. The system for blending video data with graphics data and outputting video frames comprising blended video and graphics of claim 7, where the integrated computer graphics card further comprises an analog-to-digital decoder, the analog-to-digital decoder output connected to the graphics processor by means of a first dedicated digital video bus.

10. The system for blending video data with graphics data and outputting video frames comprising blended video and graphics of claim 9, where the integrated computer graphics card further comprises a genlock control; the genlock control operatively connected between the analog-to-digital decoder, the MPEG decoder, and the video encoder, for synchronizing the timing of analog television signals input to the analog-to-digital decoder with the output of video encoder.

11. The system for blending video and graphics of claim 7, further comprising an application programming interface, for providing a plurality of procedures that allow an application program executed by the host computer to communicate with the MPEG decoder.

12. In an integrated computer graphics card connected to a host computer; the card having an MPEG decoder, a graphics processor and a graphics frame buffer, a method for blending video and graphics data on the same display, comprising the steps of:
(a) transferring MPEG data and commands to an MPEG decoder from a host computer;
(b) transferring graphics data and commands to a graphics processor from the host processor;
(c) transferring alpha data from the host processor to the graphics processor;
(d) decoding and scaling MPEG data in the MPEG processor;
(e) transferring decoded and processed MPEG data from the MPEG decoder to the graphics processor;
(f) blending the video and graphics data in the graphics frame buffer according to the alpha data; and,
(g) outputting the blended video data.

13. The method of claim 12, where the integrated computer graphics card further includes a video encoder connected to the graphics processor, for encoding digital video data to analog television formats, and a video switch connected to the video encoder and the graphics processor for switching the output of the integrated graphics card between analog and digital video outputs, further including the steps of:
a. encoding digital video data to analog television formats; and,
b. selectively switching the output of the integrated computer graphics card between NTSC/PAL TV, or VGA and HDTV formats.

14. The method of claim 13, where the integrated computer graphics card further includes an analog-to-digital encoder, and further including the steps of:
a. encoding analog television signals input to the integrated graphics card to digital video data;
b. detecting the timing of the input analog television signals;
c. detecting the timing of the MPEG decoder and the video decoder; and,
d. synchronizing the timing of the analog-to-digital encoder, the MPEG decoder, graphics processor, and the video encoder.

15. An application programming interface (API) for providing a plurality of procedures that allow an application program executed by a host computer to communicate with an integrated computer graphics card, the API functions comprising:
a. a function to create a device interface between an application program running on the host computer and an integrated computer graphics card.
b. a function to create and initially position one or more non-blended browser windows and a single video window on a given display.
c. a function to control the visibility, position and translucency of a blended browser window;
d. a function to control the position and visibility of a non-blended browser controlled window;
e. a function to control the position and visibility of a display video window, and to create one or more blended browser-controlled overlay windows;
f. a function to control the visibility, position, scroll rate and translucency of a blended scrolling bitmap window; and,
g. a function to interface to control the visibility, position, scroll rate and translucency of a non-blended scrolling bitmap window.

16. A computer-readable medium embodying an application programming interface (API) for providing a plurality of procedures that allow an application program executed by a host computer to communicate with an integrated computer graphics card, the API functions comprising:
a. a function to create a device interface between an application program running on the host computer and an integrated computer graphics card.
b. a function to create and initially position one or more non-blended browser windows and a single video window on a given display.
c. a function to control the visibility, position and translucency of a blended browser window;
d. a function to control the position and visibility of a non-blended browser controlled window;
e. a function to control the position and visibility of a display video window, and to create one or more blended browser-controlled overlay windows;
f. a function to control the visibility, position, scroll rate and translucency of a blended scrolling bitmap window; and,
g. a function to interface to control the visibility, position, scroll rate and translucency of a non-blended scrolling bitmap window.
